(19) United States
(12) Patent Application Publication
(10) Pub. No.: US 2026/0356483 A1
(43) Pub. Date: Nov. 12, 2026

(54) SYSTEM FOR DETECTING ICE OR LIQUID WATER USING CAPACITANCE MEASUREMENTS

(71) Applicant: UBIQ Aerospace AS, Trondheim (NO)

(72) Inventors: Shibarchi Majumder, Trondheim (NO); Kasper Trolle Borup, Trondheim (NO); Kim Lynge Sørensen, Trondheim (NO); Mikkel Cornelius Nielsen, Trondheim (NO); Bård Nagy Stovner, Trondheim (NO); Lars-Stephan Klein, Trondheim (NO)

(21) Appl. No.: 19/475,351

(22) PCT Filed: Apr. 11, 2024
(86) PCT No.: PCT/EP2024/059846

§ 371 Date: Oct. 14, 2025

(30) Foreign Application Priority Data
Apr. 11, 2023 (GB) 2305300.2

(51) Int. Cl. B64D 15/22; B64D 15/12; G01N 27/22; H05B 3/56

(52) U.S. Cl. CPC B64D 15/22; B64D 15/12; G01N 27/226; G01N 27/227; H05B 3/56

(57) ABSTRACT

The present invention relates to a system for, and method of, detecting the presence of ice or rain on an aircraft. In particular, the system comprises a first capacitance sensing element; a second capacitance sensing element; at least one heating element arranged to heat the first and/or second capacitance sensing elements a processor configured to: operate the at least one heating element to heat one of the first or second capacitance sensing element; monitor the capacitance in the first and second capacitance sensing elements in use; and compare the fluctuation in the capacitances monitored in each of the first and second capacitance sensing elements over time in order to determine whether ice or liquid water is present.

### FIELD OF THE INVENTION

The present invention relates to a system for, and method of, detecting the presence of ice or rain on an aircraft surface. The aircraft surface may be a wing, fuselage or propeller of an aircraft, in particular an unmanned aerial vehicle (UAV).

### BACKGROUND

Ice build-up is undesirable on most surfaces, but is particularly problematic for airborne surfaces such as the surface of a wing or propeller blade of an aircraft. Ice build-up increases the overall weight of the aircraft, which means that more lift is required in order to maintain the altitude of the aircraft. In order to increase the lift provided by the wings, the operator of the aircraft may increase the angle of attack of the wings. Depending on the severity of the ice build-up, the angle of attack may need to be increased to a point at which the wing may stall.

Moreover, significant ice build-up on an aerodynamic surface such as a wing or propeller blade can alter the profile of the surface which will affect the aerodynamic properties of the wing or propeller blade leading to an increase in drag and reduction in lift. The combination of this effect, in addition to the greater lift requirement due to the increased weight of the aircraft, further increases the likelihood of stalling the aircraft.

Ice formation is particularly problematic for small UAVs due to their light weight meaning that only a small amount of ice formation can result in a significant percentage weight change which may adversely affect the lift requirements. Moreover, ice formation can interfere with the sensors used to feedback essential information to the autopilot system.

It is therefore a requirement for aircraft, particularly UAVs, to employ ice protection (or de-icing) systems. However, ice protection systems typically require a significant amount of power and it therefore inefficient for them to be operating constantly. Typical systems may monitor the ambient temperature of the air surrounding the aircraft surface and may then activate the ice protection systems when said temperature is below a temperature where icing is likely to occur. For example, if the ambient temperature is measured at below 2 °C, conventional systems may consider it probable that icing would occur and activate the ice protection systems accordingly.

However, even if the ambient temperature is below 2 °C, there is no guarantee that icing will occur. For instance, it may be that there is not sufficient moisture in the air surrounding the surface for icing to occur, and therefore the energy-intensive de-icing systems may be activated unnecessarily. There is therefore a need to provide an improved icing detection system to ensure that icing is present on the surface, before activating the de-icing systems.

### SUMMARY

Viewed from a first aspect, there is provided a system for detecting the presence of liquid water or ice on an aircraft surface, the system comprising: a first capacitance sensing element; a second capacitance sensing element; at least one heating element arranged to heat the first and/or second capacitance sensing element; and a processor configured to: operate the at least one heating element to heat one of the first or second capacitance sensing element; monitor the capacitance in the first and second capacitance sensing elements in use; and compare the fluctuation in the capacitances monitored in the each of the first and second capacitance sensing elements over time in order to determine whether ice or liquid water is present on the surface.

The processor may be configured to monitor an ambient temperature surrounding the surface.

The system may comprise an ambient temperature sensor, wherein the ambient temperature sensor may be configured to transmit measurements to the processor. Consequently, the processor may be configured to receive the measurements of ambient temperature. The ambient temperature sensor may be integrated within the system.

Instead, the ambient temperature sensor may be part of the sensor unit of the aircraft. In particular, the ambient temperature sensor may be part of the conventional sensors located on an aircraft.

The processor may be configured to receive a measurement of the ambient temperature from the ambient temperature sensor of the sensor unit of the aircraft.

As a further alternative, the processor may be configured to receive measurements of ambient temperature from an ambient temperature sensor of the system, and a separate ambient temperature sensor which may be part of the sensor unit of the aircraft. The use of data from both sensors may serve as a verification of the ambient temperature to improve the accuracy of the measurements. The ambient temperature value may then be averaged.

The ambient temperature surrounding the surface may provide an indication of whether or not icing is likely to form on the surface. For example, if the ambient temperature is relatively high, say for example greater than 5 °C, it is unlikely that icing will form on the aircraft surface. Accordingly, the processor may be configured to only operate the at least one heating element to heat one of the first or second capacitance sensing elements if the ambient temperature is below a threshold temperature. If the ambient temperature is higher than the threshold temperature the processor may not operate the at least one heating element. In other words, the processor may be configured to de-active the at least one heating element if the ambient temperature is above a threshold temperature.

The system may be a capacitance measurement system.

As mentioned above, the threshold temperature may be the temperature where icing is likely to form.

The above arrangement reduces the electrical power consumption of the capacitance sensing elements as the at least one heating element may only be operated by the processor if the ambient temperature is at a temperature where icing is likely to form. If the ambient temperature is above this threshold, then the heating element can be deactivated to conserve energy.

The threshold temperature may be a predetermined fixed temperature. While the freezing point of water is 0 °C, in certain situations the ambient temperature may be above 0 °C, but the aircraft surface, or at least a portion of it, may be at or below 0 °C and so any water droplets present on the surface are at risk of forming ice. This situation may, for example, occur if the aircraft has rapidly reduced in altitude from a point where the ambient temperature may be below 0 °C to a point where the ambient temperature is above 0 °C. The surface temperature may begin to increase in temperature towards the “new” ambient conditions, but this will be delayed and there may be a period of time where the temperature of the surface remains below 0 °C. Accordingly, the threshold temperature (i.e., the temperature at which icing is likely to occur) may be 2 °C. Therefore, the processor may be configured to only operate the at least one heating element if the ambient temperature is measured at below 2 °C. As an alternative, the threshold temperature may be set at 0 °C.

It will also be appreciated that the setting of a threshold temperature above 0 °C may account for any uncertainty in the ambient temperature measurements. In particular, there may be a variation in the actual ambient temperature surrounding the aircraft and the monitored ambient temperature according to the sensing device used. In this regard, a higher threshold temperature may be used to account for any uncertainties to ensure that the at least one heating element is operated in the event that icing is likely to form. Therefore, the threshold temperature may be as high as 5 °C.

Alternatively, the threshold temperature may be a dynamic temperature. The dynamic temperature set as the threshold temperature may be dependent on atmospheric conditions and/or the aircraft parameters. For example, the dynamic temperature may be dependent on one or more of the ambient pressure, aircraft altitude, air speed or humidity. The processor may therefore be configured to determine a threshold temperature based on the atmospheric conditions and/or aircraft parameters.

By heating one of the first or second capacitance sensing elements as discussed above, any ice present on the surface of the heated capacitance sensing element will melt and form water droplets. The at least one heating element may therefore be configured to heat one of the first or second capacitance sensing element to a temperature greater than the freezing point of water, i.e., greater than 0 °C. In particular, the at least one heating element may be configured to heat one of the first or second capacitance sensing element to a temperature which is at least 1 °C higher than the threshold temperature, preferably at least 3 °C higher. For example, in the case that the threshold temperature is a predetermined fixed temperature of 2 °C, one of the first or second capacitance sensors may be heated to at least 3 °C, preferably at least 5 °C. However, typically the at least one heating element will heat the first or second capacitance sensing element to at least 10 °C, optionally at least 15 °C or 20 °C.

As stated above, the processor may be configured to only operate the at least one heating element to heat one of the first or second capacitance sensing element if the ambient temperature of the air surrounding the surface is below a threshold temperature. It will therefore be appreciated that if the ambient temperature monitored by the processor is above the threshold temperature, then the at least one heating element may not be operated. In other words, in this instance both the first capacitance sensing element and the second capacitance sensing element may both operate at the same temperature which corresponds with the ambient temperature of the air surrounding the surface.

The fluctuation in the capacitances monitored may be the change in the value of the capacitance monitored by the first and/or second capacitance sensing elements over a period of time. Alternative terminology may comprise a variation, variance or oscillation in the value of the capacitance monitored by the first and/or second capacitance sensing elements in use.

In particular, the fluctuation may correspond to the rising and falling in the value of the capacitance. Furthermore, the fluctuation may be considered the difference between the maximum and the minimum value of the capacitance monitored by the first and/or second capacitance sensing element. Following this principle, the processor may be configured to compare the degree of fluctuation in the capacitances monitored in the first and second capacitance sensing elements. The processor may be configured to monitor the capacitances in the first and second capacitance sensing elements over a period of time. In said period of time, the capacitance values may fluctuate, and said fluctuation may then be compared accordingly. In other words, the processor may be configured to compare the fluctuation in the capacitances monitored in each of the first and second capacitance sensing elements over a period of time in order to determine whether ice or liquid water is present.

The processor may be configured such that when the capacitances monitored on the first and second capacitance sensing elements both have a high fluctuation it indicates the presence of liquid water.

The system relies on the principle that the dielectric constant of water in liquid form is high relative to the dielectric constant of ice and air. Specifically, the dielectric constant of liquid water is approximately 80, whereas the dielectric constant of ice and air is 3 and 1 respectively. Accordingly, the capacitance value measured by a capacitance sensing element in the presence of liquid water will return a higher capacitance value than a capacitance sensing element in the presence of ice or air.

In the presence of liquid water, for example rain, the water droplets may move across a surface of the first and/or second capacitance sensing element as the aircraft moves through its environment. This may cause the monitored capacitance value in each sensing element to fluctuate between a relatively high value when a water droplet is present on the sensing element and a relative low value when no water droplet is present on the sensing element as the water droplets run along the surface.

The term “high fluctuation” in this instance may therefore be representative of a difference between a capacitance value indicative of liquid water present on the capacitance sensing element and a capacitance value indicative of air present on the capacitance sensing element. This fluctuation may therefore be proportional to the difference between the dielectric constants of liquid water and air. Moreover, the maximum capacitance value may correspond to the capacitance value that would be monitored in the presence of liquid water. Meanwhile, the minimum capacitance value may correspond to the capacitance value that would be monitored in the presence of air.

In this instance, the processor is able to determine that liquid water is present, not ice, as capacitances monitored in both the first and second capacitance sensing elements have a high fluctuation.

The frequency of the fluctuation may depend on the relative speed of the aircraft with respect to the airflow, which may have an impact on the speed at which the water droplets run across the surface.

The precise fluctuation in the value of capacitance may depend on the size of the capacitance sensing element and/or the amount of dielectric material present on the capacitance sensing element. The system may comprise determining a reference capacitance value for a capacitance sensing element. The reference capacitance value may be determined when the capacitance sensing element is dry, i.e., there is no ice or water present. During operation, the capacitance values may be compared to the reference capacitance value in the determination of whether ice and/or rain is present on the surface of the capacitance sensing elements. In particular, the processor may be configured to subtract the reference capacitance value from the measured capacitance value. This may allow the processor to determine the level of ice and/or liquid water accumulation on the surface of the first and/or second capacitance sensing element.

The processor may further be configured such that when the fluctuation in the capacitance values monitored by both the first and second capacitance sensing elements is high and within a predetermined range of each other it indicates the presence of liquid water The predetermined range should be interpreted such that the fluctuation in the capacitance values for both the first and second capacitance sensing elements may be within up to 10% of each other, preferably within less than 5% of each other, preferably within 2% of each other. This is beneficial as it accounts for any errors in the system, or slight differences in the readings in view of the factors that affect the precise fluctuation exhibited.

The processor may be configured such that when the capacitance monitored on the first and second capacitance sensing elements both have a low fluctuation it indicates the absence of both liquid water and ice.

In other words, the processor in this instance may be determine that only air is present on the capacitance sensing elements. Accordingly, given that air has a relatively low dielectric constant as discussed above, the monitored capacitance values in both the first and second capacitance sensing elements may remain low, and given that a no, or only a negligible amount of, water droplets will be present, the fluctuation in the monitored capacitance values may be low, or even zero. In particular, the monitored capacitance values in both the first and second capacitance sensing elements may remain at a level corresponding to the value indicative of air being present on the capacitance sensing element. Accordingly, the fluctuation in this instance may be zero.

The term “low fluctuation” in this instance may therefore be interpreted as a fluctuation in value at or close to the value indicative of air being present on the capacitance sensing element. Under ideal conditions, there may be no fluctuation as discussed above. However, due to certain atmospheric conditions, as well as uncertainty in the capacitance readings, there may be some fluctuation. Although this may only be a negligible amount.

The difference in the high fluctuation in the capacitance values in the presence of water as discussed above, and the low fluctuation in the presence of air, may therefore be considered as the difference in the capacitance value returned by the capacitance sensing elements in the presence of water and the capacitance value returned by the capacitance sensing elements in the presence of air. This difference may be proportional to the difference in the dielectric constants of water and air.

In this instance, given that the capacitance values monitored in both the first and second capacitance sensing elements have a low fluctuation, the processor may be able to determine the absence of both ice and liquid water. As noted above, the dielectric constant of ice is of a similar level of magnitude as air, and so it will be appreciated that the presence of ice could also lead to a low fluctuation in the capacitance value being recorded. However, the processor is able to determine in this instance that no ice is present due to the fact that one of the first or second capacitance sensing elements is heated. Therefore, if icing was present on the surface, the ice on the heated capacitance sensing element would melt to form water droplets which would result in a high fluctuation in the capacitance value in the heated capacitance sensing element due to the higher dielectric constant of liquid water. Meanwhile, for the capacitance sensing element that is not heated, the ice will remain as ice leading to a low fluctuation in the capacitance sensing elements. At the same time, in the alternative where the processor is configured to monitor the ambient temperature, and only operate the at least one heating element if the ambient temperature is below a threshold temperature, if the ambient temperature is above the threshold temperature then neither capacitance sensing elements would be heated. Accordingly, processor may determine that no icing is present simply due to the fact that the external conditions are not sufficient for ice to form, and therefore a low fluctuation in the capacitance measurement in both the first and second capacitance sensing elements indicates that only air is present.

Moreover, the volume of air present on the surface of the capacitance sensing elements may decrease as the altitude of the airborne surface increases. In addition, the moisture present in the air may contribute to the capacitance measurements, meaning that higher humidity may result in an increased fluctuation in the capacitance measurements.

The processor may be configured such that when the ambient temperature is below a threshold temperature and the capacitance monitored on the heated capacitance sensing element of the first or second capacitance sensing elements has a higher fluctuation than the capacitance monitored on the unheated capacitance sensing element of the first and second capacitance sensing elements it indicates the presence of ice.

The fluctuation in the heated capacitance sensing element may be higher than the fluctuation in the heating capacitance sensing element by an amount proportional to the difference in the dielectric constants of liquid water and ice. Accordingly, the capacitance value for the heated capacitance sensing element may fluctuate between a value indicative of liquid water and a value indicative of air. This may be caused by the water droplets formed by the melted ice running across the surface. Meanwhile, the capacitance value for the unheated capacitance sensing element may fluctuate at or close to the value indicative of ice being present on the capacitance sensing element. Under ideal conditions, there may be no fluctuation as the ice may remain stationary. However, due to certain atmospheric conditions, as well as uncertainty in the capacitance readings, there may be some fluctuation. Although, this may only be a negligible amount. In addition, under some conditions ice may move along the surface of the capacitance sensing element and therefore the monitored capacitance may fluctuate between a value indicative of ice being present and a value indicative of air being present. However, given that the dielectric constants of ice and air are of the same magnitude (i.e., they are both relatively low, especially in comparison to liquid water) this fluctuation may be low, or at least lower than the fluctuation which may be indicative of water as discussed above.

As a further verification, the processor may configured such that it only indicates the presence of ice when the fluctuation in the capacitance value monitored by the heated capacitance sensing element of the first and second capacitance sensing element is higher than the fluctuation in the unheated capacitances sensing element of the first and second capacitance sensing element by more than a predetermined threshold. The predetermined threshold may correspond broadly to the difference in capacitance values indicative of liquid water and ice, which may be due to the difference in dielectric constant. Alternatively, the predetermined threshold may correspond to at least 30% of the difference in capacitance values indicative of liquid water and ice. The presence of a predetermined threshold ensures that the processor does not indicate the presence of ice due to sensor error, and instead it may only be configured to indicate that icing may be present if the difference in the fluctuation is significant.

In this case, prior to the at least one heating element being activated, ice may be present on both the first and second capacitance sensing elements. Therefore, they may both return low capacitance values due to the relatively low dielectric constant of ice. However, due to the fact that air also has a relatively low dielectric constant, the processor may not be able to determine whether the low capacitance value is due to ice or air. Therefore, by operating the at least one heating element to heat one of the first or second capacitance sensing element, any ice present on the heated capacitance sensing element may melt to form liquid water, which may therefore allow the processor to determine that ice is present due to the high fluctuation in the capacitance monitored by the heated capacitance sensing element, and the low fluctuation in the unheated capacitance sensing element. If rain was present, rather than ice, the capacitance values in both sensing elements would have a high fluctuation. If neither ice nor rain was present, both capacitance sensing elements would be returning low capacitance values indicative of air being present on the surface as discussed in an earlier instance above.

The system may form part of an ice protection system on the aircraft, wherein the system may be used to detect the presence of ice and/or liquid water to determine whether or not the ice protection system is required.

In particular, the processor may be configured to initiate an ice protection system of the aircraft based on the determination of whether ice and/or liquid water is present on the aircraft surface. Specifically, the processor may be configured to initiate an ice protection system based on if the processor determines that ice is present on the aircraft surface. The ice protection system may comprise one or more heaters each configured to heat aircraft surface.

It will be appreciated that the monitoring of the ambient temperature and heating one of the two capacitance sensing elements allows the system to accurately determine the presence or lack of both ice and rain on a surface, and therefore avoids instances where the ice protection systems are operated unnecessarily.

In particular, the system may be able to confirm that icing is present in conditions where the ambient temperature is low enough for icing to be probable. For example, at temperatures below 2 °C, at certain altitudes and with sufficient moisture content, ice formation would be likely to occur, but there may be occurrences at this temperature where the specific atmospheric conditions are not sufficient for icing to form. Pre-existing system may simply assume that ice formation will occur at these low temperatures, and activate the necessary ice protection systems unnecessarily. Advantageously, the present invention operates to reliably confirm that ice is present, so that the ice protection system is only activated when necessary.

The system is therefore able to reduce the demand of the ice protection systems by ensuring that icing is present before activating them. This allows the overall system to conserve energy and the overall operating efficiency of the aircraft is thereby increased. This is of particular benefit for UAVs which may be powered by small-scale batteries, and the ice protection systems may be energy intensive. The measurement system according to the first aspect herein can therefore increase the operating time of the UAV.

In addition to the above, it may be that when the ambient temperature is below the threshold temperature where icing is likely to occur there may not be sufficient moisture in the air for icing to form. In this case, the processor may be configured to monitor the ambient pressure and/or humidity of the surrounding air.

The processor may be configured to correlate the operation of the at least one heating element with one or more of the ambient pressure and humidity of the surrounding air. As the specific heat of water is higher than for air, the at least one heating element may require additional power from the power supply when the surrounding air has a higher water content. Therefore, the correlation of the operation of the at least one heating element, including the power supplied to it, and the pressure and/or humidity in the air can be used to detect the presence of ice.

The discussion thus far relates primarily to the systems use for detecting the presence of ice, liquid water, or air present on the surface. It will also be appreciated that the system may preferably be configured to determine if the capacitance sensing elements, or any part of the measurement system, may not be working correctly. Accordingly, the processor may be configured such that when the ambient temperature is below the threshold temperature and the capacitance monitored in the heated capacitance sensing element of the first or second capacitance sensing element has a lower fluctuation than the capacitance monitored in the unheated capacitance sensing element of the first or second capacitance sensing element by more than a threshold it indicates that at least one of the first and second capacitance sensing elements is malfunctioning.

In this case, due to the fact that the ambient temperature is below the threshold temperature, icing may be likely to form. Assuming that icing is present, in the case of the heated capacitance sensing element, the ice may melt to form liquid water, while ice may still be present on the unheated capacitance sensing element. This would result in the unheated capacitance sensing element returning a higher fluctuation than the unheated capacitance sensing element for the reasons discussed above. Conversely, assuming that no icing is present, despite the temperature being below the threshold, then both the heated and unheated capacitance sensing elements may have either liquid water or simply air present on their respective surface, which would return a low fluctuation in the monitored capacitance values for both the capacitance sensing elements. Accordingly, in the present case where the ambient temperature is below the point where icing is likely to form, the capacitance monitored in the heated capacitance sensing element having a lower fluctuation than the capacitance monitored in the unheated capacitance sensing element may be an unexpected response. The processor may therefore determine that the system is malfunctioning in some manner.

Similarly, the processor may be configured such that when the ambient temperature is at a temperature above the threshold temperature and the fluctuation in the capacitance monitored in the first capacitance sensing element differs by more than a predetermined threshold from the fluctuation in the capacitance monitored in the second capacitance sensing element it indicates that at least one of the first and second capacitance sensing elements is malfunctioning.

In this instance, the ambient temperature is at a point where icing is not likely to occur, and so the system may assume that either liquid water or air is present on the surface. Regardless of whether or not the processor being configured to heat one of the first and second capacitance sensing element, the first and second capacitance sensing elements should return substantially the same monitored capacitance values as they are under the same conditions. Therefore, in this case where ambient temperature may be above the point at which icing is likely to occur, and the fluctuation differing by more than an acceptable amount, i.e., by a predetermined threshold, is an unexpected response. Accordingly, the processor may indicate a malfunction in the system. In addition, in the case where the processor is only configured to operate the heating element in the event that the ambient temperature is below the threshold temperature, as the temperature in this instance is above this threshold temperature, the at least one heating element may not be operated by the processor. Therefore, both the first and second capacitance sensing elements are under the same conditions, and so the medium present on both the first and second capacitance sensing elements should be the same and therefore have the same dielectric constant, meaning that the monitored capacitance values should be the same. A significant deviation in the capacitance values may therefore indicate that at least one of the first or second capacitance sensing elements are malfunctioning.

Here, a predetermined threshold may be interpreted in the same way as the instance referred to above where the processor may be configured to detect that rain is present, or that neither ice or rain are present on the surface. In particular, the predetermined threshold may be 5-10%. The percentage difference may be based on the lower of the two degrees of fluctuation in the monitored capacitance values. Alternatively, the percentage difference may be based on the value from the first capacitance sensing element or the second capacitance sensing element. The presence of a predetermined threshold is advantageous as it ensures that correct determinations of the presence of ice and/or liquid water are still recognized. For instance, even when the system is working correctly, there may be deviations in the degrees of capacitance values monitored in both the first and second capacitance sensing elements. This may be due to the specific set-up of each capacitance sensing element, such as the calibration, or the specific local conditions present on the surfaces of each of the first and second capacitance sensing elements.

The processor may be configured to issue an alert for maintenance in response to the processor indicating that at least one of the first or second capacitance sensing elements are malfunctioning.

Alternatively, the processor may be configured such that when the ambient temperature is below the threshold temperature and the capacitance monitored in the heated capacitance sensing element of the first or second capacitance sensing element has a lower fluctuation than the capacitance monitored in the unheated capacitance sensing element of the first or second capacitance sensing element by more than a threshold it indicates the presence of contaminant or debris other than ice or liquid water on the first and/or second capacitance sensing elements.

Similarly, the processor may be configured such that when the ambient temperature is at a temperature above the threshold temperature and the fluctuation in the capacitance monitored in the first capacitance sensing element differs by more than a predetermined threshold from the fluctuation in the capacitance monitored in the second capacitance sensing element it indicates the presence of contaminant or debris other than ice or liquid water on the first and/or second capacitance sensing elements.

The processor may determine that the first and second capacitance sensing elements are operating correctly, but that the unexpected responses in the monitored capacitance values for the first and second capacitance sensing elements may be due to other substances being present. The processor may be configured to repeat the step of monitoring the capacitance in the first capacitance sensing element and the second capacitance sensing element. The processor may then be configured to repeat the step of comparing the fluctuation in the capacitances monitored in each of the first and second capacitance sensing elements.

If the processor continues to indicate the presence of contaminant or debris on the first and/or second capacitance sensing elements, the processor may then be configured to indicate that one or both of the first and second capacitance sensing elements is malfunctioning and/or damaged. More specifically, if the processor indicates the presence of contaminant or debris on the first and/or second capacitance sensing elements three or more times, the processor may then be configured to indicate that one or both of the first and second capacitance sensing elements is malfunctioning and/or damaged.

The at least one heating element may be directly coupled to one of the first or second capacitance sensing elements. More specifically, the at least one heating element may be in direct contact with the first or second capacitance sensing element, or in contact via a heat transferring medium.

The at least one heating element may be an electrical element, such as a resistive wire. The at least one heating element may be connected to a power source, and the power source may be controlled by a logic controlled switch.

The processor may be configured to control the logic controlled switch in response to the ambient temperature. Specifically, the processor may be configured to activate the logic controlled switch in response to the monitored ambient temperature being at or below a temperature where icing is likely to occur.

The at least one heating element configured to heat one of the first or second capacitance sensing elements may be a first heating element. The system may then comprise a second heating element. The second heating element may be configured in the same way as the first heating element.

The second heating element may be configured to heat the other of the first or second capacitance sensing elements. For example, the first heating element may be configured to heat the first capacitance sensing element, and the second heating element may be configured to heat the second capacitance sensing element, or vice versa.

The above arrangement whereby the system may comprise two heating elements improves the versatility of the system. In particular, the processor may be configured to alternate which of first or second capacitance sensing elements are heated. This may improve the long-term reliability of the system.

In both cases where the system comprises at least one heating element, or when it comprises a first and second heating element, it will be understood that the processor may be configured to operate only one heating element during the monitoring and comparing steps of the first aspect, such that it will heat only one of the first or second capacitance sensing elements. The processor may therefore also be configured to not operate the other of the first or second heating elements.

Furthermore, in response to the processor indicating the presence of ice, as further verification step, the processor may be configured to operate the second heating element, in addition to the first heating element, to heat the other of the first or second capacitance sensing elements, i.e., the previously “unheated” capacitance sensing element. The processor may then be further configured such that if the capacitance monitored in the other of the first or second capacitance sensing element subsequently exhibits a high fluctuation, it confirms the presence of ice. Additionally, if the fluctuation in the capacitance monitored in the other of the first or second capacitance sensing element remains low, the processor may indicate that the system is malfunctioning.

In this scenario, ice may have accumulated on the surface of the previously unheated capacitance sensing element, hence why the respective monitored capacitance value may have a low fluctuation. Once the “unheated” capacitance sensing element is heated, the ice may melt to form liquid water and subsequently result in a high fluctuation in the monitored capacitance for the reasons discussed above connected to the high dielectric constant of water compared to ice. In this instance, the first and second heating elements may be operated to heat the first and second capacitance sensing elements to the same temperature. Accordingly, if ice is present on the surface, the monitored capacitances in both the first and second capacitance sensing elements should have the same or similar fluctuation indicative of liquid water being present.

The processor may be configured to initiate an ice protection system of the aircraft based on the determination of whether ice or liquid water is present. In particular, in the instance where the processor is configured to indicate the presence of ice, the processor may then be further configured to initiate the ice protection system. The ice protection system may comprise means for removing ice present on the surface of the aircraft. The means for removing ice may comprise one or more heating elements which may be located within the surface of the aircraft.

The processor may be configured to operate both the first and second heating elements based on the determination of whether ice or liquid water is present. In particular, in the case where the processor is configured to indicate the presence of ice, the processor may be configured to operate both the first and second heating elements simultaneously. This arrangement ensures the removal of ice that is present on the surfaces of the first and second capacitance sensing elements.

The capacitance measurements system may comprise temperature sensor. The temperature sensor may be configured to monitor one of the first and second capacitance sensing elements. The system may comprise a second temperature sensor, wherein the second temperature sensor may be configured to monitor the other of the first and second capacitance sensing elements. Alternatively, the system may comprise a single temperature sensor which may be configured to monitor the temperature of both the first and second capacitance sensing elements. The temperature sensor(s) may be connected to the processor by a connector. The temperature sensor(s) may allow the processor to accurately control the heating of the first and/or second capacitance sensing element.

The capacitance sensing measurement system may be mounted on a structure which may extend from the aircraft surface. The structure may extend in a direction which is perpendicular to the surface. This allows the first and second capacitance sensing elements to be exposed within the airflow.

As an alternative, the system may be embedded within the aircraft surface so that the capacitance sensing elements are flush with the surface.

The surface of the aircraft may be any surface of the aircraft, such as a wing, a portion of the fuselage, or a propeller blade.

The first capacitance sensing element and the second capacitance sensing elements may be positioned adjacent to each other. Moreover, the first capacitance sensing element and the second capacitance sensing element may be positioned adjacent to each other in a vertical direction. In particular, the first capacitance sensing element may be positioned vertically above the second capacitance sensing element, or vice versa.

In this arrangement, the processor may be configured to operate the at least one heating element to heat the lower capacitance sensing element of the first and second capacitance sensing element. For example, if the first capacitance sensing element is positioned below the second capacitance sensing element in the vertical direction, the processor may be configured to heat the first capacitance sensing element.

This means that if ice was present on the surface of the lower capacitance sensing element of the first and second capacitance sensing elements, when it melts it does not run over the surface of the other of the first and second capacitance sensing element and disrupt the capacitance measurement of the other capacitance sensing element.

It will be appreciated that the orientation of the first and second capacitance sensing elements may change during the flight of the aircraft. Accordingly, the presence of a first and second heating element is of particular benefit as this means the processor may be configured to operate either the first or second heating element to heat either the first or second capacitance sensing element depending on which of the first and second capacitance sensing element is in the lower position at the time of monitoring the capacitance.

The system may comprise a core comprising an aerofoil section. The core may be a structure, preferably an aerodynamic structure, which may extend from the surface of the aircraft. In this instance, the aerodynamic structure of the core may comprise an aerofoil cross section. Alternatively, the core may be a portion of the aircraft, such as the wing of the aircraft.

The system may comprise a flexible printed circuit board extending over at least a portion of the core. The flexible printed circuit board may comprise the first capacitance sensing element and the second capacitance sensing element. In the case where the core is a structure extending from the surface of the aircraft, the flexible printed circuit board may extend over substantially all of the core. However, in the case where the core is a portion of the aircraft, such as the wing, the flexible printed circuit board may only extend over a portion of the surface at which the detection of liquid water or ice is configured to take place.

The at least one heating element may be a flexible heating element which may be positioned between the core and the flexible printed circuit board. The flexible heating element may be located at a position that coincides with the position of one of the first or second capacitance sensing elements.

The resulting assembly may therefore form a sandwich structure of the core, with the flexible heating element located around the core, and then the flexible printed circuit board located around the flexible heating element.

The flexible heating element may be a first flexible heating element, and the system may further comprise a second flexible heating element. The second flexible heating element may be located at a position that coincides with the position of the other of the first or second capacitance sensing elements on the flexible printed circuit board. The first and second heating elements may be configured to be operated in the event of ice formation occurring on the capacitance sensing elements.

The system may comprise a flexible heating layer, which may comprise one or both of the first and second flexible heating elements. In particular, the flexible heating layer may be a single laminate layer with one or more heated portions. The heated portions may comprise an electrical element, such as a resistive wire, embedded within the laminate which may form the one or more flexible heating elements. In an alternative arrangement, each of the first and second flexible heating elements may be a separate laminate layer, which may be positioned adjacent to each other to coincide respectively with the position of the first and second capacitance sensing elements.

The flexible heating element may comprise one or more heated portions. In particular, the one or more heated portions may comprise an electrical element, for example a resistive wire.

Although the components of the first and/or second capacitance sensing elements have been described in connection with the overall system as part of the first aspect of the present invention, it will be appreciated that the assembly of each capacitance sensing assembly may be considered independently of the system.

Accordingly, viewed from a second aspect, there is provided a capacitance sensing assembly comprising: a core comprising an aerofoil cross section; a flexible printed circuit board extending over at least a portion of the core and comprising a first capacitance sensing element and a second capacitance sensing element; a flexible heating element positioned between the core and the flexible printed circuit board at a position that coincides with the position of one of the first or second capacitance sensing elements.

The capacitance sensing assembly of the present aspect may comprise any of the features discussed in relation to the capacitance sensing element in the first aspect above. In particular, the first and second capacitance sensing elements may be configured to operate in the same manner as the one or both the capacitance sensing elements described in the first aspect.

Most notably, the core may comprise an aerodynamic structure extending from a surface of an aircraft, or the core may comprise a wing of an aircraft. The flexible heating element may be a first heating element, and the assembly may comprise a second flexible heating element which may be positioned between the core and the flexible printed circuit board at a position that may coincides with the position of the other one of the first or second capacitance sensing elements. Each or both of the first and second flexible heating element may be configured to operate in the same manner as the at least one heating element described in the first aspect above.

More generally, the capacitance sensing assembly may comprise any of the features discussed in relation to the system of the first aspect, and may therefore be configured to operate in the same manner. For instance, a processor may be provided and may be configured to operate in the same manner as the processor described in the first aspect above.

Viewed from a third aspect, which may be considered an alternative to the assembly described in the second aspect above, there is provided a capacitance sensing assembly comprising: a capacitance sensing element including a capacitor, a heating element; a metallic element located between the capacitance sensing element and the heating element; and a moisture absorbent material located directly adjacent to the capacitance sensing element.

The moisture absorbent material may be formed of porous material, or any material capable of absorbing and holding moisture, such as a microfiber cloth or sponge.

The moisture absorbent material may be positioned directly adjacent to the capacitor of the first and/or second capacitance sensing element. The moisture absorbent material may be positioned such that it is flush with the surface, and it may also be in direct contact with the air surrounding the surface. The moisture absorbent material may cover the entire surface of the capacitor of the capacitance sensing element.

The moisture absorbent material may be of benefit as it means that any moisture which may be present on the surface during operation will be held in position on the first and/or second capacitive sensing element. This allows for a more accurate capacitive measurement to be taken.

The metallic element may be sized to match the size and shape of a capacitive element of the first and/or second capacitance sensing element. The metallic heat element may be positioned between the capacitive element of the first and/or second capacitance sensing element and the heating element. The metallic element may provide uniform heating of the first and/or second capacitance sensing element. In this instance, the metallic element may be formed of a metal with good heat conducting properties, such as copper or aluminum.

One or both of the first and second capacitance sensing elements may comprise a temperature sensor. The temperature sensor may be connected to the processor by a connector. The temperature sensor may be integrated with the metallic element. The temperature sensor may allow the processor to accurately control the heating of the first and/or second capacitance sensing element.

The capacitance sensing assembly of the third aspect may be used as part of the system as described in the first aspect above, as an alternative to the arrangement described in the second aspect above.

According to a fourth aspect, there is provided an ice protection system for an aircraft, the ice protection system comprising the system according to the first aspect for detecting the presence of ice and/or liquid water on a surface of the aircraft.

The ice protection system may comprise a means for preventing and/or removing ice build-up on the aircraft surface.

The processor of the system may be configured to activate the means for preventing and/or removing ice build-up on the aircraft surface in response to the indication of whether ice and/or rain is present on the aircraft surface. For example, if the processor is configured to indicate that ice is present, the processor may activate the means for preventing and/or removing ice build-up on the aircraft surface.

According to a fifth aspect, there is provided an aircraft comprising one or more surfaces, wherein the aircraft comprises the system according to the first aspect for detecting the presence of ice and/or rain on one or more of the surfaces.

The aircraft may be a UAV.

The aircraft may comprise a plurality of systems in accordance with the first aspect. For instance, each separate surface may comprise a separate system.

The capacitance sensing measurement system may be mounted directly on to the surface of the aircraft, whereby it may be embedded within the surface of the aircraft. Alternatively, the capacitance sensing measurement system may be mounted on a structure which extends from the surface. The structure may extend in a direction which is perpendicular to the surface. This allows the first and second capacitance sensing elements to be exposed within the airflow.

The first and second capacitance sensing element of the capacitance sensing measurement system may be mounted to the surface, or to the structure, in a vertical configuration. Each of the first and second capacitance sensing element may be mounted such that the capacitors are parallel with the surface the capacitance sensing elements are mounted to. More specifically, the capacitors may be flush with the surface they are mounted to. In this instance, the surface the capacitance sensing elements are mounted to may be the surface of the aircraft, or the structure extending from the surface.

The aircraft may comprise an ice protection system, wherein the ice protection system may be as described in the fourth aspect above.

The invention also extends to the corresponding method of operation of the system, accordingly, viewed from a sixth aspect, there is provided a method for detecting the presence of ice and/or liquid water on an aircraft surface, wherein the surface is provided with a first capacitance sensing element, a second capacitance sensing element, and at least one heating element arranged to heat the first and/or second capacitance sensing element, the method comprising: heating one of the first or second capacitance sensing elements using the at least one heating element; monitoring the capacitance in the first and second capacitance sensing elements; comparing the fluctuation in the capacitances monitored in the first and second capacitance sensing element over time in order to determine whether ice or liquid water is present on the surface.

The method according to the sixth aspect may comprise any of the features discussed in connection with the first to fifth aspects above, including any of the steps the processor is configured to carry out as defined in the first aspect above.

Most notably, the method may comprise monitoring an ambient temperature surrounding the surface. The method may comprise only heating one of the first or second capacitance sensing elements if the ambient temperature is below a threshold temperature. The threshold temperature may be a temperature at which icing is likely to form.

In particular, the method may comprise indicating that liquid water is present on the surface if the capacitances monitored on the first and second capacitance sensing elements both have a high fluctuation.

The method may comprise indicating that absence of both ice and liquid water are present on the surface if the capacitance monitored on the first and second capacitance sensing elements both have a low fluctuation.

The method may comprise indicating that ice is present on the surface if the ambient temperature is below a threshold temperature and the capacitance monitored on the heated capacitance sensing element of the first or second capacitance sensing elements has a higher fluctuation than the unheated capacitance sensing element of the first and second capacitance sensing elements.

The method may comprise initiating an ice protection system of the aircraft if the method determines that ice is present on the aircraft surface.

The discussion thus far regarding the system and associate method has focused primarily on the system whereby the processor is configured to compare the fluctuation in the monitored capacitance values in each of the first and second capacitance sensing elements. However, as an alternative approach, the system may monitor compare the capacitances directly, instead of the fluctuation in the values.

Therefore, according to a further seventh aspect, there is provided a system for detecting the presence of ice and/or liquid water on an aircraft surface, the system comprising: a first capacitance sensing element; a second capacitance sensing element; at least one heating element; a processor configured to: operate the at least one heating element to heat one of the first or second capacitance sensing element; measure the capacitance in the first and second capacitance sensing elements; and compare the capacitances measured in the first and second capacitance sensing elements in order to determine whether ice or rain is present on the surface.

As with the first aspect above, the processor may be configured to monitor an ambient temperature surrounding the surface. Accordingly, the processor may also be configured to only operate the at least one heating element to heat one of the first or second capacitance sensing elements if the ambient temperature is below a threshold temperature. The threshold temperature may be as described in the first aspect above.

The system according to the seventh aspect relies on the same principle as the first aspect above, namely, that the dielectric constant of water in liquid form is high relative to the dielectric constant of ice and air. Specifically, the dielectric constant of liquid water is approximately 80, whereas the dielectric constant of ice and air is 3 and 1 respectively. Accordingly, the capacitance value measured by a capacitance sensing element in the presence of liquid water will return a higher capacitance value than a capacitance sensing element in the presence of ice or air. However, in this aspect, the system may be comparing the raw values of the capacitance measured in each of the first and second capacitance sensing elements.

The processor may be configured such that when the capacitances measured in the first and second capacitance sensing elements are both high and within a predetermined range of each other it indicates that liquid water is present on the surface. The term “high” in this instance should be interpreted as the capacitance reading indicative of liquid water being present on the surface of the capacitance sensing element.

It will be appreciated that the term “high” may be a relative value indicative of a capacitance sensing element where water is present compared to a dry capacitance sensing element. The precise value of capacitance may depend on the size of the capacitance sensing element and/or the amount of dielectric material present on the capacitance sensing element. The system may comprise determining a reference capacitance value for a capacitance sensing element. The reference capacitance value may be determined when the capacitance sensing element is dry, i.e., there is no ice or water present. During operation, the capacitance values may be compared to the reference capacitance value in the determination of whether ice and/or rain is present on the surface of the capacitance sensing element. In particular, the processor may be configured to subtract the reference capacitance value from the measured capacitance value. This may allow the processor to determine the level of ice and/or water accumulation on the surface of the first and/or second capacitance sensing element.

In addition, the predetermined range should be interpreted such that the values recorded by both the first and second capacitance sensing elements may be within up to 10% of each other, preferably within less than 5% of each other, preferably within 2% of each other.

In this instance, if both the first and second capacitance sensing elements record high capacitance values, the processor determines that rain is present due to the fact that water has a much higher dielectric constant than ice. Therefore, given that both the first and second capacitance sensing elements measure a high capacitance value, water must be present on both the first and second capacitance sensing elements.

The processor may be configured such that when the capacitance measured in the first and second capacitance sensing elements are both low and within a predetermined range of each other it indicates that neither ice or liquid water are present on the surface. The term “low” in this instance should be interpreted as the capacitance reading indicative of either ice or air being present on the surface of the capacitance sensing element. As discussed above, the dielectric constant of ice is approximately 3, and the dielectric constant of air is 1. As will be appreciated, the dielectric constants of ice and water are significantly lower than the dielectric constant of water and so the measurements of the capacitance elements will be significantly lower in the presence of ice or air, than with water.

In this instance, given that both the first and second capacitance sensing elements measure a low capacitance value neither ice or water are present. In more detail, while it will be appreciated that the presence of ice can lead to a low capacitance value being recorded, the processor is able to determine in this instance that no ice is present due to the fact that if the ambient temperature is below a point where ice is likely to form (i.e., less than 2 °C), then one of the first or second capacitance sensing element is heated to a temperature at which any ice would melt. Therefore, if icing was present on the surface, the ice on the heated capacitance sensing element would melt to form water leading to a high capacitance measurement in the heated capacitance sensing element, and a low capacitance sensing element in the unheated capacitance sensing element, where no heat is applied meaning that ice would still be present.

Similarly, if the ambient temperature is above a point where ice is likely to form, the processor may determine that no icing is present simply due to the fact that the external conditions are not able to freeze the moisture, and therefore a low capacitance measurement in both the first and second capacitance sensing elements indicates that only air is present.

The processor may be configured such that when the ambient temperature is below the threshold temperature and the capacitance measured in the heated capacitance sensing element of the first or second capacitance sensing element is higher than the capacitance measured in the unheated capacitance sensing element of the first or second capacitance sensing element by more than a predetermined threshold it indicates that ice is present on the surface.

The predetermined threshold in this instance may correspond to the difference between the dielectric constants of liquid water and ice. In particular, the capacitance measurement from the unheated capacitance sensing element may correspond to the expected capacitance value if water is present on the heated capacitance sensing element, and the capacitance measurement from the unheated capacitance sensing element may correspond to the expected capacitance value if ice is present on the unheated capacitance sensing element.

In this case, prior to the at least one heating element being activated, ice may be present on both the first and second capacitance sensing elements. Therefore, they may both return low capacitance values due to the relatively low dielectric constant of ice. However, due to the fact that air also has a relatively low dielectric constant, the processor may not be able to determine whether the low capacitance value is due to ice or air. Therefore, by operating the at least one heating element to heat one of the first or second capacitance sensing element, any ice present on the heated capacitance sensing element may melt.

In this situation the processor may therefore be able to determine that icing is present due to the high value returned by the heated capacitance sensing element (i.e., indicating the presence of water from the melted ice) and the low value returned by the unheated capacitance sensing element which must be due to ice, given that the heated capacitance sensing element is indicating the presence of water. If rain was present, rather than ice, both sensing elements would be returning high capacitance values. If neither ice or rain was present, both capacitance sensing elements would be returning low capacitance values indicative of ice being present on the surface.

While the step of comparing the capacitances in each of the first and second capacitance sensing elements to determine the presence of liquid water or ice for the seventh aspect may be different to the corresponding comparison step in the first aspect, the system according to the seventh aspect may comprise any of the other features described in connection with the first to fifth aspects above.

### BRIEF DESCRIPTION OF THE DRAWINGS

Certain preferred embodiments of the present invention will now be described, by way of example only, with reference to the following drawings, in which:

FIG. 1 shows a system for detecting the presence of ice and liquid water on a surface using capacitance measurements;

FIG. 2 shows an algorithm for controlling the system to detect the presence of ice and liquid water on a surface;

FIG. 3 shows an alternative algorithm for controlling the system to detect the presence of ice and liquid water on a surface;

FIG. 4A shows a schematic of a capacitance measurement system;

FIG. 4B shows another schematic of the capacitance measurement system shown in FIG. 4A;

FIG. 4C shows another schematic of a capacitance measurement system shown in FIG. 4A;

FIG. 5 shows a front view of a capacitive sensing element assembly;

FIG. 6 shows a side view of the capacitive sensing element assembly shown in FIG. 4;

FIG. 7A shows a side view of the capacitance measurement system mounted to an airborne surface; and

FIG. 7B shows a front view of capacitance measurement system mounted to an airborne surface.

### DETAILED DESCRIPTION

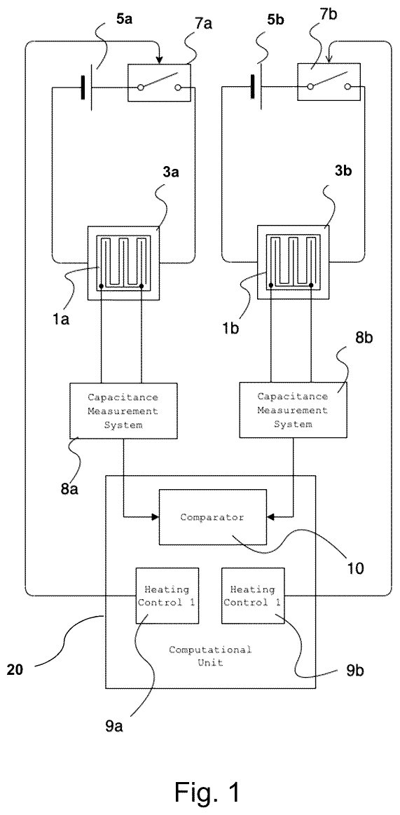

FIG. 1 shows a capacitance measurement system which can be implemented on a surface in order to detect the presence of ice and/or liquid water (i.e., rain or water droplets). In the present example, the surface is an airborne surface such as wing or fuselage of an aircraft, specifically of a UAV.

The system comprises a first capacitance sensor element 1a and a second capacitive sensor element 1b. Each of the first and second capacitance element comprises a capacitor including two capacitive plates. The system comprises a first heating element 3a which is at a position corresponding to the position of the first capacitance sensing element 1a. The first heating element 3a is powered by a first power source 5a operated by a first logic controlled switch 7a. The system further comprises a second heating element 3b which is at a position corresponding to the position of the first capacitance sensing element 3b. The second heating element 3b is powered by a second power source 5b operated by a second logic controlled switch 7b.

The system comprises a processor 20 which includes a comparator 10, a first heating control 9a and a second heating control 9b. In operation, the first heating control 9a is configured to control the first logic controlled switch 7a for activating the first power source 5a to provide power to the first heating element 3a and heat the first capacitive sensing element 1a accordingly. Likewise, the second heating control 9b is configured to control the second logic controlled switch 7b to activate the second power source 5b to provide power to the second heating element 3b and heat the second capacitive sensing element 1b accordingly.

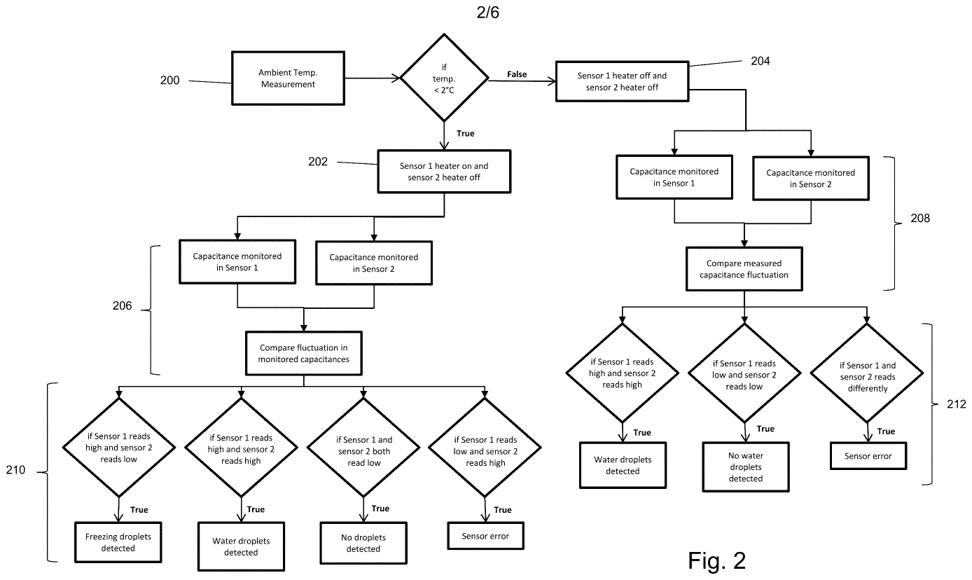

The capacitance in each of the first and second capacitance sensor elements 1a and 1b are measured by the first capacitance measurement system 8a and the second capacitance measurement system 8b respectively. The comparator 10 in the processor 20 is then configured to operate according to an algorithm to identify the presence of ice or liquid water, or neither, based on the measurements derived by the first and second capacitance measurements systems 8a, 8b and operate the first and/or second heaters 3a, 3b accordingly in line with the process described in relation to FIG. 2 below.

FIG. 2 depicts the algorithm operated by the processor 20 which is used by the system to detect the presence of ice and/or liquid water on a surface, specifically an airborne surface.

As an initial step, the processor 20 determines 200 the ambient temperature surrounding the surface. In the case of the surface being an airborne surface, this ambient temperature measurement may be taken from a temperature sensor on the aircraft, which may be an existing temperature sensor. The processor 20 would therefore be configured to receive the measurement of the ambient temperature from the ambient temperature sensor. Alternatively, the capacitance system may comprise a designated ambient temperature sensor in order to monitor the ambient temperature directly, without the need to receive data from the pre-existing ambient temperature sensor. As another alternative, the processor may be configured to receive ambient temperature measurements from an ambient temperature sensor on the aircraft and an ambient temperature sensor of the capacitance measurement system. This use of two different readings can be used to verify the ambient temperature.

If the ambient temperature is below 2 °C, then the processor 20 determines that there is a possibility that icing may have occurred. In this instance, the first heating control 9a of the processor 20 activates 202 the first logic controlled switch 7a, which in turn activates the first power source 5a to heat the first capacitive sensing element 1a using the first heating element 3a.

The capacitances in the first capacitance sensing element 1a and second capacitance sensing element 2a are then monitored 206 by the first and second capacitance measurement systems 8a, 8b respectively and the measurements are supplied to the comparator 10 within the processor 20. The comparator 10 compares the fluctuation in the monitored capacitances from each of the first and second capacitance sensing elements 1a, 1b.

The value of the capacitance measurements in each of the first and second capacitive sensing elements 1a, 1b is affected primarily by the dielectric constant of the medium present on the respective sensing element. In particular, the dielectric constant of water is approximately 80, while the dielectric constant of ice is significantly lower at about 3. Meanwhile, the dielectric constant of air is 1. The presence of water would therefore result in a relatively high capacitance measurement, while the presence of ice or air would result in a relatively low capacitance reading. Accordingly, the fluctuation in the capacitance values will also be affected by the dielectric constant of the medium present, as will be discussed in more detail below.

Based on this concept, the comparator 10 within the processor 20 is able to determine 210 whether ice or rain, or neither, is present on the surface depending on the values measured by each capacitance measurement system 8a, 8b.

The comparator determines that ice is present if the fluctuation in the capacitance monitored in the first, heated, capacitance sensing element 1a is higher than the fluctuation in the capacitance monitored in the second, unheated, capacitance measurement system 8b for the second capacitance sensing element 1b is low. The reason for this is that the first capacitance sensing element 1a has been heated by the first heating element 3a, which causes any ice present on the first capacitance sensing element 1a to melt to become liquid water. As the water droplets move across the surface of the capacitance sensing element 1a, the capacitance value will fluctuate between a relative high value indicative of liquid water being present, and a relatively low value indicative of air being present. Meanwhile, as the second capacitance sensing element 1b is not heated, the ice present will remain as ice. This will result in a very low fluctuation in the capacitance monitored in the second capacitance sensing element 1b.

It will therefore be appreciated that the term “high fluctuation” in this instance would correspond to difference in the expected capacitance value if liquid water were present on the surface of the capacitance sensing element 1a, 1b and the expected capacitance value of air were present on the surface of the capacitance sensing element 1a, 1b. Likewise, the term “low” in this instance would correspond to the expected capacitance value if ice or air were present on and around the surface of the capacitance sensing element 1a, 1b.

The comparator 10 will determine that only liquid water is present on the surface, not ice, if the fluctuation in the capacitances monitored in both the first and second capacitance measurement systems 8a, 8b are high. This is due to the fact that although the first capacitance sensing element 1a, which is heated, is exhibiting a high fluctuation in the capacitance value, the second capacitance sensing element 1b, which is not heated, is also exhibiting a high degree of fluctuation in the capacitance value indicating that water is present on the second capacitance sensing element 1b as well as the first capacitance sensing element 1a.

The comparator will determine that neither ice nor rain is present on the surface if the fluctuation in the capacitances monitored in both the first and second capacitance measurement systems 8a, 8b are low. In this instance, the low fluctuation in the capacitance values are the result of only air being present on the first and second capacitive sensing elements 1a, 1b. Therefore, heating the first capacitive sensing element 1a has no effect on the capacitance value recorded, and the fact that neither capacitance sensing elements 1a, 1b are measuring a high value indicates that there is no water present, either from rain or ice melting.

As a final alternative, the comparator determines that one or both of the capacitive sensing elements 1a, 1b is/are malfunctioning if the fluctuation in the capacitances monitored in the first capacitance measurement system 8a related to the first capacitance sensing element 1a, which is heated, is lower than the capacitance monitored from the second capacitance measurement system 8b. Given that the first capacitance sensing element 1a is heated such that any ice would have melted, a relatively low fluctuation in the capacitance measurement system 8a indicates that no ice or rain is present. However, the relatively high fluctuation in the capacitance monitored in the second capacitance sensing element 1b would normally indicate the presence of liquid water in this context, which is in contradiction to the measurement from the first capacitance sensing element 1a. Therefore, it is determined that one or both of the capacitance sensing elements 1a, 1b are malfunctioning.

In this instance, the processor 20 may indicate to the operator of the aircraft that the sensor is not functioning correctly, and this may prompt a need for maintenance. As a precaution, given that the ambient temperature is below 2 °C, the aircraft may activate the de-icing systems as the low ambient temperature means that that icing is likely.

If at step 200 it is determining that the temperature is above 2 °C, then the processor 20 determines that icing is unlikely. In this instance, the processor 20 deactivates 204 both the first logic-controlled switch 7a and the second logic-controlled switch 7b so that neither the first or second heating elements 3a, 3b are powered by their respective power sources 5a, 5b.

The capacitances in each of the first capacitance sensing element 1a and second capacitance sensing element 1b are then monitored 208 by the first and second capacitance measurement systems 8a, 8b, and the fluctuations in the capacitance values are compared accordingly to determine 212 whether or not liquid water is present on the surface.

The comparator will determine that liquid water is present on the surface if the fluctuation in the capacitances monitored in both the first and second capacitance measurement systems 8a, 8b are high. This is due to the fact that the higher dielectric constant of water compared to air, results in a high fluctuation in the value of the capacitance as the water droplets move across the surface. Meanwhile, the fact that the ambient temperature is measured at above 2 °C means that the processor 20 determines that ice is not present on the surface.

The comparator 10 determines that there is no liquid water present if the fluctuation in the capacitances monitored in both the first and second capacitance measurement systems 8a, 8b are low, given that the dielectric constant of air is significantly lower than water, and the fact that the ambient temperature being above 2 °C means that icing is unlikely.

Finally, the comparator 10 determines that one or both of the first and second capacitance sensing elements 1a, 1b are malfunctioning if the fluctuation in the capacitances monitored in both the first and second capacitance measurement systems 8a, 8b differ by more than a predetermined threshold. Given that neither of the first or second heating elements 3a, 3b are activated, both sensors should be subject to the same conditions, and therefore the medium on each capacitance sensing element 1a, 1b should have the same dielectric constant and result in the same capacitance measurement, or at least where the capacitance measurements from each capacitance sensing elements are within a predetermined threshold of each other. For example, the deviation between the two capacitance measurements may be up 5-10% to account for any minor variations in the monitored capacitances due to the properties of the sensor, or minor differences in the mediums present. In this instance, the processor 20 may notify the operator that one or both of the capacitance sensing elements 1a, 1b is/are not operating correctly, and the necessary maintenance can then be carried out.

FIG. 3 shows an alternative algorithm for operating the processor in the determination of whether ice or liquid water are present on the aircraft surface. In particular, instead of monitoring the fluctuation in the capacitance values, the processor may be configured to compare the raw capacitance values measured by each capacitance sensing element.

Accordingly, the algorithm depicted in FIG. 3 comprises the steps of determining the ambient temperature 100 as is the case in FIG. 2. Similarly, if the ambient temperature is below 2 °C, then the processor 20 determines that there is a possibility that icing may have occurred. In this instance, the first heating control 9a of the processor 20 activates 102 the first logic controlled switch 7a, which in turn activates the first power source 5a to heat the first capacitive sensing element 1a using the first heating element 3a.

The capacitance measurements are then determined 106 by the first and second capacitance measurement systems 8a, 8b from each of the first and second capacitance sensing elements 1a, 1b respectively and the measurements are supplied to the comparator 10 within the processor 20.

The value of the capacitance measurements in each of the first and second capacitive sensing elements 1a, 1b is affected primarily by the dielectric constant of the medium present on the respective sensing element. In particular, the dielectric constant of water is approximately 80, while the dielectric constant of ice is significantly lower at about 3. Meanwhile, the dielectric constant of air is 1. The presence of water would therefore result in a high capacitance measurement, while the presence of ice or air would result in a low capacitance reading.

Based on this concept, the comparator 10 within the processor 20 is able to determine 110 whether ice or rain, or neither, is present on the surface depending on the values measured by each capacitance measurement system 8a, 8b.

If the capacitance measurement from the first capacitance measurement system 8a for the first capacitance sensing element 1a is high, and the capacitance measurement from the second capacitance measurement system 8b for the second capacitance sensing element 1b is low, the comparator 10 determines that ice is present on the surface. The reason for this is that the first capacitance sensing element 1a has been heated by the first heating element 3a, which causes the ice present on the first capacitance sensing element 1a to melt to become water and therefore result in a high capacitance measurement. Meanwhile, as the second capacitance sensing element 1b is not heated, the ice present will remain as ice and result in a low capacitance measurement.

It will therefore be appreciated that the term “high” in this instance would correspond to the expected capacitance value if water were present on the surface of the capacitance sensing element 1a, 1b. Likewise, the term “low” in this instance would correspond to the expected capacitance value if ice or air were present on and around the surface of the capacitance sensing element 1a, 1b.

If the capacitance measurements from both the first and second capacitance measurement systems 8a, 8b are high, then the comparator will determine that only rain is present on the surface, not ice. This is due to the fact that although the first capacitance sensing element 1a, which is heated, is recording a high capacitance value, the second capacitance sensing element 1b, which is not heated, is also recording a high value indicating that water is be present on the second capacitance sensing element 1b as well as the first capacitance sensing element 1a.

If the capacitance measurements from both the first and second capacitance measurement systems 8a, 8b are low, then the comparator will determine that neither ice nor rain is present on the surface. In this instance, the low capacitance values are the result of only air being present within the first and second capacitive sensing elements 1a, 1b. Therefore, heating the first capacitive sensing element 1a has no effect on the capacitance value recorded, and the fact that neither capacitance sensing elements 1a, 1b are measuring a high value indicates that there is no water present, either from rain or ice melting.

As a final alternative, if the capacitance measurement from the first capacitance measurement system 8a related to the first capacitance sensing element 1a, which is heated, is low, and the capacitance measurement from the second capacitance measurement system 8b is high, then the comparator determines that one or both of the capacitive sensing elements 1a, 1b are/is malfunctioning. Given that the first capacitance sensing element 1a is heated, a low capacitance measurement system 8a indicates that no ice or rain is present. However, the high capacitance value measured at the second capacitance sensing element 1b would normally indicate the presence of water in this context, which is in contradiction to the measurement from the first capacitance sensing element 1a. Therefore, it is determined that one or both of the capacitance sensing elements 1a, 1b are malfunctioning.

In this instance, the processor 20 may indicate to the operator the aircraft that the sensor is not operating correctly, and this may prompt a need for maintenance. As a precaution, given that the ambient temperature is below 2 °C, the aircraft may activate the de-icing systems as the low ambient temperature means that that icing is likely.

As was also the case for the algorithm in FIG. 2, in the present case the shown in FIG. 3, if at step 100 it is determining that the temperature is above 2 °C, then the processor 20 determines that icing is unlikely. In this instance, the processor 20 deactivates 104 both the first logic controlled switch 7a and the second logic controlled switch 7b so that neither the first or second heating elements 3a, 3b are powered by their respective power sources 5a, 5b.

The capacitance measurements in each of the first capacitance sensing element 1a and the second capacitance sensing element 1b is then determined 108 by the first and second capacitance measurement systems 8a, 8b. If the capacitance measurements from both the first and second capacitance measurement systems 8a, 8b are high, then the comparator will determine that rain is present on the surface. This is due to the fact that the higher dielectric constant of water compared to air, results in a higher capacitance value being recorded. Meanwhile, the fact that the ambient temperature is measured at above 2 °C means that the processor 20 determines that ice is not present on the surface.

If the capacitance measurement from both the first and second capacitance measurement systems 8a, 8b are low values, then the comparator 10 determines that there is no rain present, given that the dielectric constant of air is significantly lower than water, and the fact that the ambient temperature being above 2 °C means that icing is unlikely.

Finally, if the capacitance measurements from both the first and second capacitance measurement systems 8a, 8b differ, then the comparator 10 determines that one or both of the first and second capacitance sensing elements 1a, 1b are malfunctioning. Given that neither of the first or second heating elements 3a, 3b are activated, both sensors should be subject to the same conditions, and therefore the medium on each capacitance sensing element 1a, 1b should have the same dielectric constant and result in the same capacitance measurement, or at least where the capacitance measurements from each capacitance sensing elements are within a predetermined threshold of each other. For example, the deviation between the two capacitance measurements may be up 5-10%. In this instance, the processor 20 may notify the operator that one or both of the capacitance sensing elements 1a, 1b is/are not operating correctly, and the necessary maintenance can then be carried out.

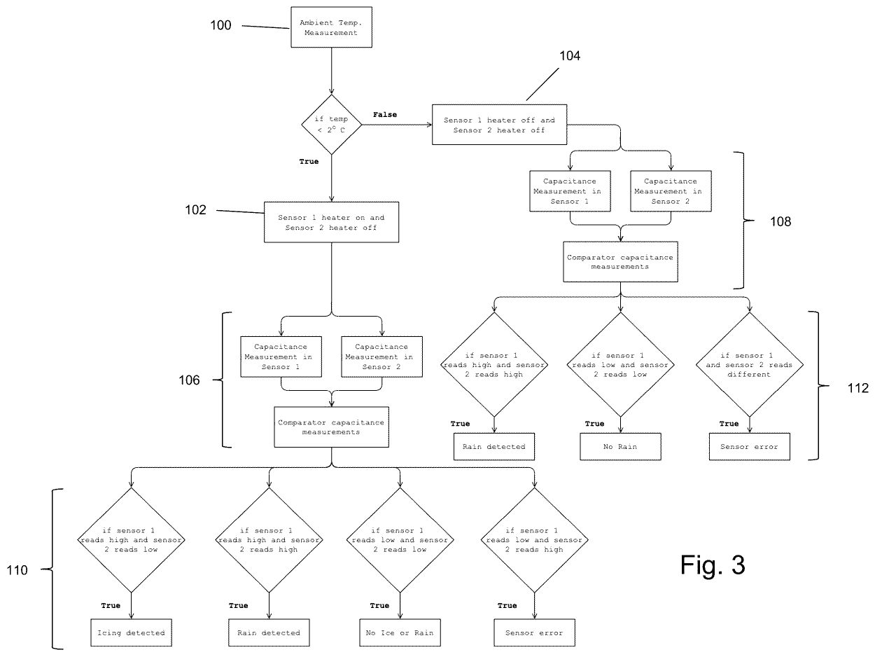

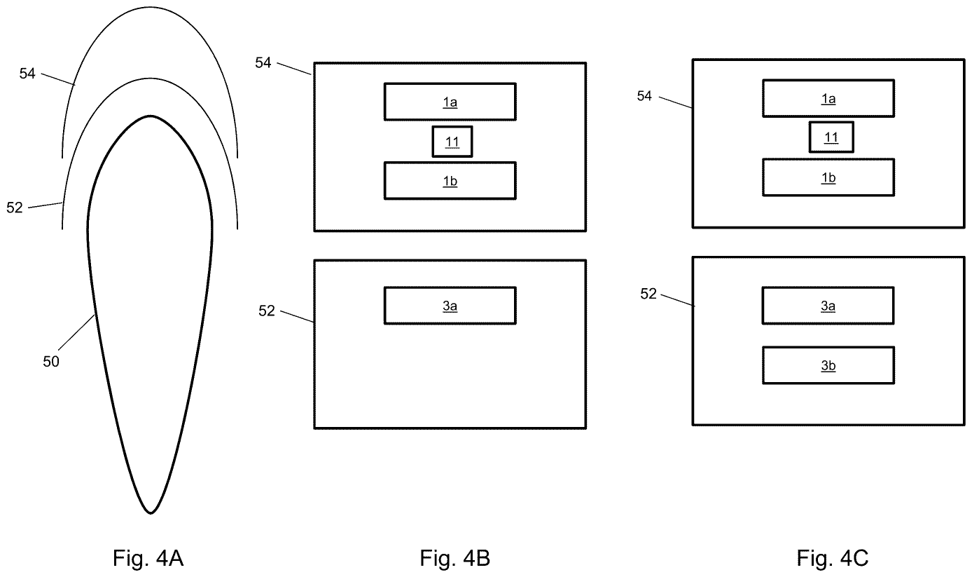

FIG. 4 shows a schematic arrangement of the capacitance measurement system. In particular FIG. 4A depicts a first view of the capacitance measurement system, and FIGS. 4B and 4C depict two schematic arrangements of the capacitance measurements system from a second view.

The capacitance measurement system comprises a core 50, a flexible heating element 52 which is laid over a portion of the core 50, and a flexible printed circuit board 54 which is laid over the flexible heating element. Accordingly, the flexible heating element 52 is sandwiched between the core 52 and the flexible printed circuit board 54.

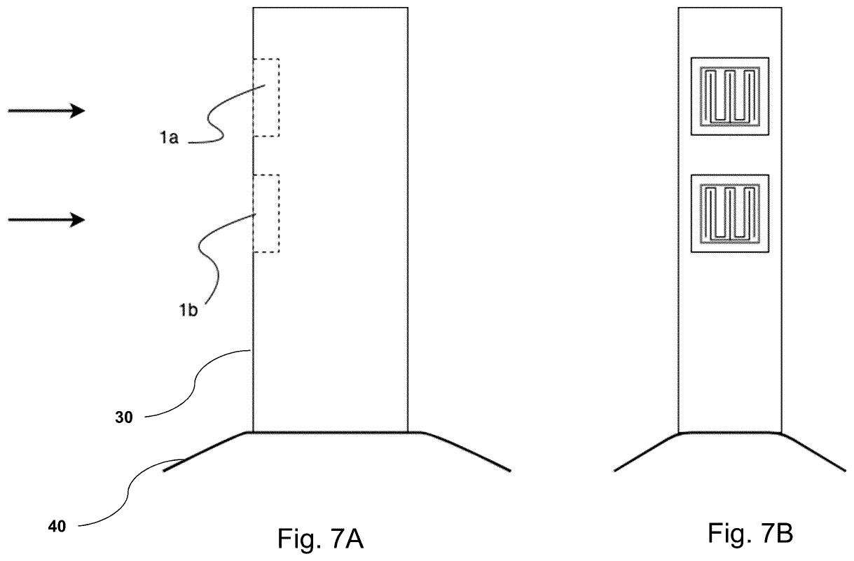

The core 50 comprises an aerofoil cross section. The core may be an aerodynamic structure extending from the surface of an aircraft, as depicted in FIGS. 7 and 8. Alternatively, the core 50 may be a portion of the aircraft, such as the wing.

The flexible printed circuit board 54 comprises the first capacitance sensing element 1a and the second capacitance sensing element 1b. The flexible printed circuit board also comprises a temperature sensor 11 which is configured to monitor the temperature of the first and second capacitance sensing elements 1a, 1b in order to maintain a desired temperature.

As shown in FIG. 4B, the flexible heating element 52 comprises a first heated portion 3a which is located at a position which corresponds with the position of the first capacitance sensing element 1a. Therefore, when assembled, if the first heated portion 3a is activated it is configured to heat the first capacitance sensing element 1a.

FIG. 4C shows another arrangement whereby the flexible heating element 52 comprises a second heated portion 3b, in addition to the first heated portion 3a. The second heated portion 3b is located at a position corresponding to the position of the second capacitance sensing element 1b. In this regard, when assembled, the second heated portion 3b is configured to heat the second capacitance sensing element 1b.

The assembly shown in FIG. 4 depicts the heating element as a single flexible heating element 52 with one or more heated portions 3a, 3b. However, it will be appreciated that one or more flexible heating element 52 may be provided and sized and position to correspond with the size and position of the first and second capacitance sensing elements 1a, 1b respectively.

The heated portions 3a, 3b may be electrical elements, such as resistive wires, connected to the power sources 5a, 5b as depicted in FIG. 1.

In the case of the flexible heating element 52 comprises two heated portions 3a, 3b, the processor 20 can vary which of the first or second capacitance sensing elements 1a, 1b are heated during the process of determining whether ice or liquid water are present.

In addition, in the case where the processor determines the presence of ice on the surface, the processor can operate the other of the heated portions 1b to heat the other of the first or second capacitance sensing elements 1a, 1b. Accordingly, both capacitance sensing elements 1a, 1b will then be heated. Any ice present on the previously unheated capacitance sensing element 1a, 1b will therefore melt resulting in a higher fluctuation in the capacitance value than the fluctuation present for the unheated capacitance sensing element. This can serve as a verification step for determining the presence of ice on the surface.

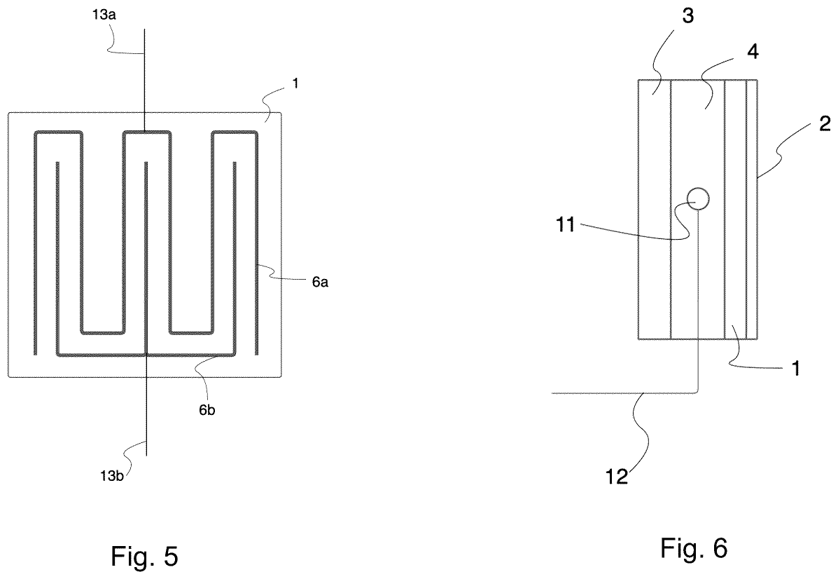

FIG. 5 shows an arrangement of the capacitance sensing element to be used with the capacitance measurement system. The capacitance sensing element assembly 1 comprises a first channel 6a and a second channel 6b. In operation, the dielectric material (e.g., ice, rain or air) fills the space between the first channel 6a and the second channel 6b in order to form a capacitor. The capacitance sensing assembly 1 also comprises a first connector 13a and a second connector 13b which connects the first channel 6a and the second channel 6b respectively to one of the capacitance measurement systems 8a and 8b. The other capacitance sensing element assembly is then connected by its respectively connector to the other capacitance measurement system 8a, 8b.

The capacitance measurement systems 8a, 8b operate as passive capacitance measurement systems by analyzing AC (filter) responses where a waveform generator transmits a signal of known frequency to the capacitor to periodically charge the capacitor. In particular, the capacitance measurement systems 8a and 8b use the capacitance in the components as a regulating factor in a resistor-capacitor filter circuit such that as water or ice accumulates on the surface of the capacitance sensing element 1, the capacitance of the sensing element increases which reduces a reactance of the capacitance sensing element 1. The rate of ice and/or water accumulation on the capacitance sensing element 1 can be directly correlated to the rate of change of reactance in the capacitance sensing element 1. This allows the user to effectively understand the severity of the ice or rain conditions present on the airborne surface.

FIG. 6 shows a cross section a capacitive sensing assembly which comprises a capacitive sensing element 1, and may be considered an alternative arrangement to that depicted in FIG. 4 above. In the view shown in FIG. 6, the air flow is intended to be from right to left. The capacitance sensing assembly comprises a water absorbent material 2, such as a piece of microfiber cloth or a sponge, which covers the capacitance sensing element 1 and holds moisture on the surface. The water absorbent material 2 is able to improve the accuracy of the measurement by ensuring that if rain/water is present, which may lead to ice, the water will be held in place on the sensing surface 1. If said water absorbent material 2 was not present, the water or moisture may run off the surface of the capacitance sensing element 1 due to gravity. This can lead to deviations in the capacitance measurements

The capacitance sensing assembly comprises a heating element 3, which is powered by the power source 5 shown in FIG. 1. The heating element 3 is powered by the power source 5 dependent on the logic controlled switch 7, which in turn is activated according to the algorithm depicted in FIG. 2. In order to ensure uniform heating, the capacitance sensing assembly comprises a piece of metal 4 located between the heater 3 and the capacitance sensing element 1. The metal 4 is preferably a good conductor of heat such as aluminum or copper to ensure that the heat from the heater 3 is uniformly distributed across the entire surface area of the sensing assembly.

In addition, the capacitance sensing assembly comprises a temperature sensor 11 embedded within the piece of metal 4. A connector 12 connects the temperature sensor 11 to the processor 20 to ensure the sensing assembly is heated to the required temperature for the capacitance measurement to be carried out.

FIG. 7 depicts the first and second capacitance sensing elements 1a, 1b fitted to a structure 30. FIG. 7A shows a side view of the surface 30 comprising the first and second capacitance sensing elements 1a, 1b, wherein the direction of the airflow is from left to right as depicted by the arrows. FIG. 7A then depicts a front on view of the surface 30 comprising the first and second capacitance sensing elements 1a, 1b, wherein the direction of the airflow would be directly into the page.

The embodiment shown in FIG. 7 may comprise the capacitance measurement assembly as described in relation to FIG. 4 above, whereby the surface 30 may be a surface of the core 50. The capacitance sensing elements 1a, 1b may be a part of the flexible printed circuit board 54, and a flexible heating element may be laid over a portion of the surface 30. Alternatively, the embodiment of FIG. 7 may comprise the capacitance measurement assembly described in relation to FIG. 6, whereby the assembly is mounted to the surface 30.

In the present embodiment, the surface 30 is a vertical structure extending from an airborne surface 40. For example, the airborne surface may be the fuselage or wing of an aircraft. Alternatively, the surface 30 may be the surface of the aircraft itself, or a propeller surface. The first and second capacitance sensing elements 1a, 1b are arranged in a vertical configuration, i.e., where one of the first and second capacitance sensing elements 1a, 1b is located above the other in the vertical direction.

Due to the configuration of the first and second capacitance sensing elements 1a, 1b, if the ambient temperature is detected as below 2 °C then the processor 20 configures the lower of the two capacitance sensing elements to be heated. In the embodiment shown in FIG. 7, it would be the second capacitance sensing elements 1b that is heated. In this case, if icing was present on one or both of the sensing elements, then water formed by melting the ice on the second capacitance sensing element 1b would simply run downwards due to gravity along the surface. If the upper capacitance sensing element, i.e., the first capacitance sensing element 1a, was heated, then the water formed by melting the ice would run over the surface of the lower capacitance sensing element and disrupt the capacitance measurement. This may lead to the lower capacitance sensing element 1b returning a high capacitance value and the processor 20 may then incorrectly determine that water is present, not ice as may be the case.

In an alternative configuration, the first and second capacitance sensing elements 1a, 1b may be arranged in a horizontal configuration, i.e., where the first and second capacitance sensing elements 1a, 1b are located side-by-side adjacent to one another. In this instance, either the first or second capacitance sensing element 1a, 1b may be the heated capacitance sensing element.

1. A system for detecting the presence of liquid water or ice on an aircraft surface, the system comprising:
a first capacitance sensing element;
a second capacitance sensing element;
at least one heating element arranged to heat the first and/or second capacitance sensing elements;
a processor configured to:
operate the at least one heating element to heat one of the first or second capacitance sensing elements;
monitor the capacitance in the first and second capacitance sensing elements in use; and
compare the fluctuation in the capacitances monitored in each of the first and second capacitance sensing elements over time in order to determine whether ice or liquid water is present.

2. The system as claimed in claim 1, wherein the processor is configured such that when the capacitances monitored on the first and second capacitance sensing elements both have a high fluctuation it indicates the presence of liquid water.

3. The system as claimed in claim 1, wherein the processor is configured such that when the capacitance monitored on the first and second capacitance sensing elements both have a low fluctuation it indicates the absence of both liquid water and ice.

4. The system as claimed in claim 1, wherein the processor is configured to monitor an ambient temperature surrounding the aircraft surface.

5. The system as claimed in claim 4, wherein the processor is configured such that when the ambient temperature is below a threshold temperature and the capacitance monitored on the heated capacitance sensing element of the first or second capacitance sensing elements has a higher fluctuation than the capacitance monitored on the unheated capacitance sensing element of the first and second capacitance sensing elements it indicates the presence of ice, optionally wherein the threshold temperature is the temperature below which icing is likely to form, optionally wherein the threshold temperature is 2 °C.

6. The system as claimed in claim 4, wherein the processor is configured such that when the ambient temperature is below a threshold temperature and the capacitance monitored in the heated capacitance sensing element of the first or second capacitance sensing element has a lower fluctuation than the capacitance monitored in the unheated capacitance sensing element of the first or second capacitance sensing element by more than a threshold it indicates that at least one of the first and second capacitance sensing elements is malfunctioning.

7. The system as claimed in claim 4, wherein the processor is configured such that when the ambient temperature is at a temperature above a threshold temperature and the fluctuation in the capacitance monitored in the first capacitance sensing element differs by more than a predetermined threshold from the fluctuation in the capacitance monitored in the second capacitance sensing element it indicates that at least one of the first and second capacitance sensing elements is malfunctioning, and/or wherein the processor is configured to only operate the at least one heating element to heat one of the first or second capacitance sensing element if the ambient temperature is below a threshold temperature.

8. (canceled)

9. (canceled)

10. The system as claimed in claim 1, wherein the processor is configured to initiate an ice protection system of the aircraft based on the determination of whether ice or liquid water is present.

11. The system as claimed in claim 1, wherein the at least one heating element is an electrical element, optionally a resistive wire.

12. The system as claimed in claim 1, wherein the at least one heating element is a first heating element, and the system comprises a second heating element, optionally, wherein the first heating element is configured to heat the first capacitance sensing element, and the second heating element is configured to heat the second capacitance sensing element.

13. (canceled)

14. The system as claimed in claim 12, wherein the processor is configured to operate both the first and second heating elements based on the determination of whether ice or liquid water is present.

15. The system as claimed in claim 1, comprising a temperature sensor configured to monitor the temperature of the first and second capacitance sensing elements.

16. The system as claimed in claim 1, wherein the system is mounted on a structure which extends from the aircraft surface.

17. The system as claimed in claim 1, wherein the system is embedded within the aircraft surface so that the capacitance sensing elements are flush with the aircraft surface, optionally wherein the aircraft surface is a wing.

18. A method for detecting the presence of ice and/or liquid water on an aircraft surface, wherein the aircraft surface is provided with a first capacitance sensing element, a second capacitance sensing element, and at least one heating element arranged to heat the first and/or second capacitance sensing elements, the method comprising:
heating one of the first or second capacitance sensing elements using the at least one heating element;
monitoring the capacitance in the first and second capacitance sensing elements;
comparing the fluctuation in the capacitances monitored in the first and second capacitance sensing element in order to determine whether ice or liquid water is present on the surface.

19. A capacitance sensing assembly comprising:
a core comprising an aerofoil cross section;
a flexible printed circuit board extending over at least a portion of the core and comprising a first capacitance sensing element and a second capacitance sensing element;
a flexible heating element positioned between the core and the flexible printed circuit board at a position that coincides with the position of one of the first or second capacitance sensing elements.

20. The capacitance sensing assembly according to claim 19, wherein the core is an aerodynamic structure extending from a surface of an aircraft, or, wherein the core is a wing of an aircraft.

21. (canceled)

22. The capacitance sensing assembly according to claim 19, wherein the flexible heating element is a first heating element, and the assembly comprises a second flexible heating element positioned between the core and the flexible printed circuit board at a position that coincides with the position of the other one of the first or second capacitance sensing elements, optionally, wherein the first and second heating elements are configured to be operated in the event of ice formation occurring on the capacitance sensing assembly.

23. (canceled)

24. The capacitance sensing assembly according to claim 19, comprising one or more temperature sensors configured to monitor a temperature of the first and second capacitance sensing elements.

25. An ice protection system for an aircraft, the ice protection system comprising;
the system according to claim 1 for detecting the presence of ice and/or liquid water on a surface of the aircraft; and a means for preventing and/or removing ice build-up on the aircraft surface in response to the indication of whether ice and/or liquid water is present on the aircraft surface.
